(19) United States
(12) Patent Application Publication
(10) Pub. No.: US 2013/0079912 A1
(43) Pub. Date: Mar. 28, 2013

(54) METHODS AND SYSTEMS FOR SEMICONDUCTOR FABRICATION WITH LOCAL RETICLE MANAGEMENT

(71) Applicant: Chinmay S. Oza, Mechanicville, NY (US)

(72) Inventor: Chinmay S. Oza, Mechanicville, NY (US)

(73) Assignee: GLOBALFOUNDRIES INC., Grand Cayman (KY)

(21) Appl. No.: 13/245,576

(22) Filed: Sep. 26, 2011

(51) Int. Cl. G06F 19/00

(52) U.S. Cl. 700/100

(57) ABSTRACT

A method and system of semiconductor fabrication are provided. In the method, an equipment unit performs a process on substrates using a current reticle. The equipment unit also communicates processing data to a local reticle controller. The local reticle controller schedules removal of the current reticle from the equipment unit and delivery of a subsequent reticle to the equipment unit based on the processing data for further substrate processing.

### TECHNICAL FIELD

This document generally relates to methods and systems for semiconductor fabrication, and more particularly relates to such methods and systems that provide local management of reticles.

### BACKGROUND

In the global market, manufacturers of mass products must offer high quality devices at a low price. It is thus important to improve yield and process efficiency to minimize production costs. This holds especially true in the field of semiconductor fabrication, where it is essential to combine cutting-edge technology with volume production techniques. It is the goal of semiconductor manufacturers to reduce the consumption of raw materials and consumables while at the same time improving process tool utilization. The latter aspect is especially important since, in modern semiconductor facilities, equipment is required which is extremely cost intensive and represents the dominant part of the total production costs.

Integrated circuits are typically manufactured in automated or semi-automated facilities, by passing substrates in and on which the devices are fabricated through a large number of process steps to complete the devices. The number and the type of process steps a semiconductor device has to go through may depend on the specifics of the semiconductor device to be fabricated. For instance, a sophisticated CPU may require several hundred process steps, each of which has to be carried out within specified process margins to fulfill the specifications for the device under consideration.

Typical integrated circuit fabrication includes photolithography steps performed on the substrates at a photolithography process tool or module, such as a stepper or scanner. In a photolithography process, the stepper or scanner passes light through a reticle to create a pattern on a photoresist-coated substrate. Typically, the reticle, or photomask, is a patterned quartz plate. While the process tool or module may be able to hold a few reticles for use, during processing, reticles are delivered and removed from the process tool or module in order to maintain efficient fabrication. Further, due to varying and small lot sizes of substrates, and due to the use of multiple reticles with a single lot of substrates, movement of reticles in and out of a process tool or module may be quite frequent. As a result, fabrication may be slowed due to the presence of substrates at a process tool or module without the required reticle or reticles.

Nevertheless, it remains an important aspect with respect to productivity to coordinate the process flow within the manufacturing environment in such a way that high efficiency of tool utilization is achieved. This is a critical cost factor due to the investment costs and the moderately low “life span” of semiconductor process tools, and is a significant component in the determination of the price of fabricated semiconductor devices.

Accordingly, it is desirable to provide semiconductor fabrication methods and systems that reduce process tool idle time and increase tool utilization by reducing time intervals between the completion of a processing step on a lot of substrates with a reticle and the commencement of a processing step with a subsequent reticle. It is also desirable to provide semiconductor fabrication methods and systems that utilize local management of reticles to reduce process tool idle time. Furthermore, other desirable features and characteristics of the semiconductor fabrication methods and systems will become apparent from the subsequent detailed description and the appended claims, taken in conjunction with the accompanying drawings and this background.

### BRIEF SUMMARY

Methods and systems for semiconductor fabrication are provided. In accordance with one exemplary embodiment, an equipment unit performs a process on substrates using a current reticle. The equipment unit also communicates processing data to a local reticle controller. The local reticle controller schedules removal of the current reticle from the equipment unit and delivery of a subsequent reticle to the equipment unit based on the processing data for further substrate processing.

In another embodiment, a method of semiconductor fabrication employs local reticle management. In the method, a plurality of equipment units is provided. Each equipment unit is associated with a respective local reticle controller. A process is performed on substrates with a first equipment unit using a current reticle. Further, the first equipment unit communicates processing data to its associated local reticle controller. The associated local scheduler schedules removal of the associated current reticle from the first equipment unit to a first local reticle storage and delivery of a subsequent reticle from the first local reticle storage to the first equipment unit based on the processing data.

In accordance with another exemplary embodiment, a semiconductor fabrication system is provided. The system includes an equipment unit configured to perform a process on substrates using a current reticle to form processed substrates and configured to produce processing data. The system also includes a local reticle storage configured to hold reticles and to transport reticles to and from the equipment unit. In the semiconductor fabrication system, a local reticle controller is in communication with the equipment unit and the local reticle storage and is configured to schedule removal of current reticles from the equipment unit and delivery of subsequent reticles to the equipment unit based on the processing data.

### BRIEF DESCRIPTION OF THE DRAWINGS

Exemplary embodiments will hereinafter be described in conjunction with the following drawing figures, wherein like numerals denote like elements, and wherein:

FIG. 1 is a schematic view of a semiconductor fabrication system in accordance with an exemplary embodiment;

FIG. 2 is a flow chart representing the method performed by the semiconductor fabrication system of FIG. 1; and

FIGS. 3-5 are schematic views of a semiconductor fabrication system in accordance with various exemplary embodiments.

### DETAILED DESCRIPTION

The following detailed description is merely exemplary in nature and is not intended to limit the semiconductor fabrication methods and systems contemplated herein. Furthermore, there is no intention to be bound by any theory presented in the preceding background or the following detailed description.

As detailed below, the semiconductor fabrication methods and systems utilize local management of reticles used in photolithography processes. Specifically, local reticle controllers are used for single tools, or for groups of tools, to provide improved scheduling, i.e., reduced idle times for tools. Further, the local reticle controllers may be used for single local reticle storage units, or for groups of local reticle storage units. The local reticle controllers are scalable across different types of tools and logic systems. As a result, the local reticle controllers may be utilized universally throughout a semiconductor fabrication facility (a “fab”) to provide the facility with a universal high reticle availability solution. The local reticle controllers provide the ability to maintain multiple distributed reticle control and scheduling across tools and storage units having different manufacturers and associated software and logic.

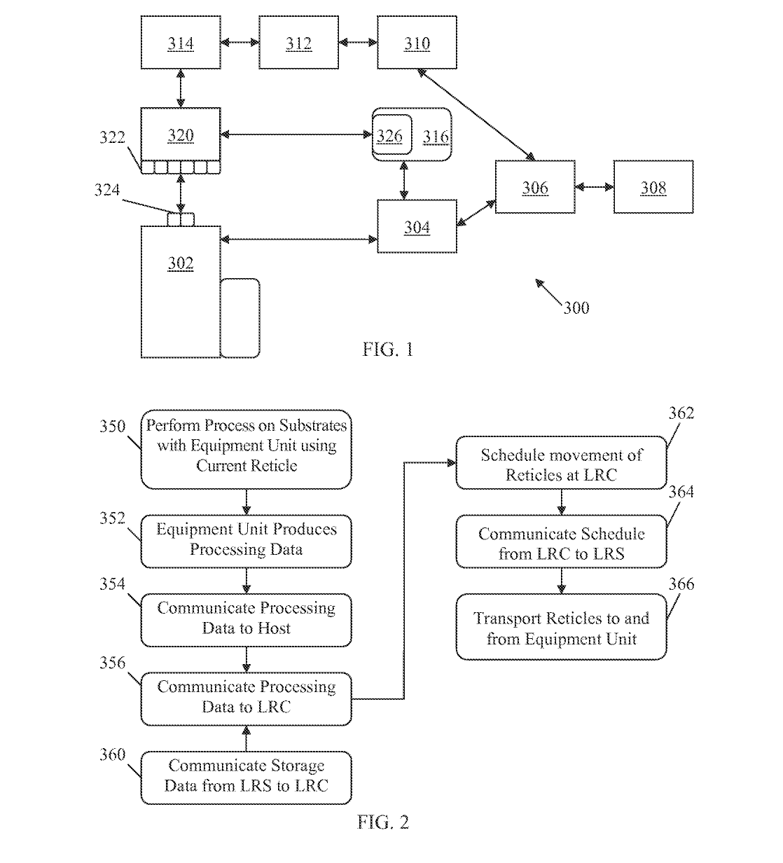

As shown, the semiconductor fabrication system 300 in FIG. 1 incorporates local reticle management in order to reduce or eliminate idle time of tools that utilize reticles. The system 300 includes an equipment unit 302, which may be a process module or process tool for performing a photolithography process or any other process requiring use of a reticle. “Equipment unit” is used herein to refer to any process equipment, such as process modules and process tools. As further shown, equipment unit 302 is in communication with an equipment interface (EI) or host controller (host) 304.

The host 304 is in communication with a Manufacturing Execution System (MES) 306. Further, the MES 306 transmits and receives data from a Real Time Dispatch (RTD) 308. The MES 306 is also shown to be in communication with an Automated Material Handling System Equipment Interface (AMHS-EI) 310. The AMHS-EI 310 communicates with an AMHS Material Control System (MCS) 312. Further, the MCS 312 communicates with a transport system 314 such as an overhead transport system.

As shown in FIG. 1, the system 300 also includes a local reticle controller 316. Specifically, the local reticle controller 316 communicates directly with the host 304 to receive equipment data. Further, the local reticle controller 316 is in communication with a local reticle storage unit 320. As shown, the local reticle storage unit 320 includes a plurality of input/output ports 322 for receiving reticle pods that carry reticles. Further, the input/output ports 322 are arranged for interaction with equipment ports 324 on the equipment unit 302. As a result, reticle pods or reticles may be exchanged between the equipment unit 302 and local reticle storage unit 320. The local reticle storage unit 320 may be an overhead reticle pod buffer, a buffer attached to the equipment unit, a stationary reticle pod buffer near the equipment unit for directly delivering reticle pods to the equipment unit ports 324, or of another design or arrangement. In any case, the local reticle storage unit 320 is preferably positioned in close proximity to the equipment unit.

In system 300, a scheduler 326 is positioned at the local reticle controller 316. Further, the local reticle controller 316 receives processing data which may include a predicted process completion time, the identity of reticles at the equipment unit 302, the number of steps remaining in a process with a current reticle at the equipment unit 302, the status of equipment ports 324 (whether vacant or occupied) at the equipment unit 302, the status of input/output ports 322 (vacant or occupied) at the local reticle storage unit 320, equipment temperature data, storage device temperature data, sensor information, process parameters, preventative maintenance data, carrier state information, substrate location and/or process data, and/or robot interlock information among other equipment and storage device information.

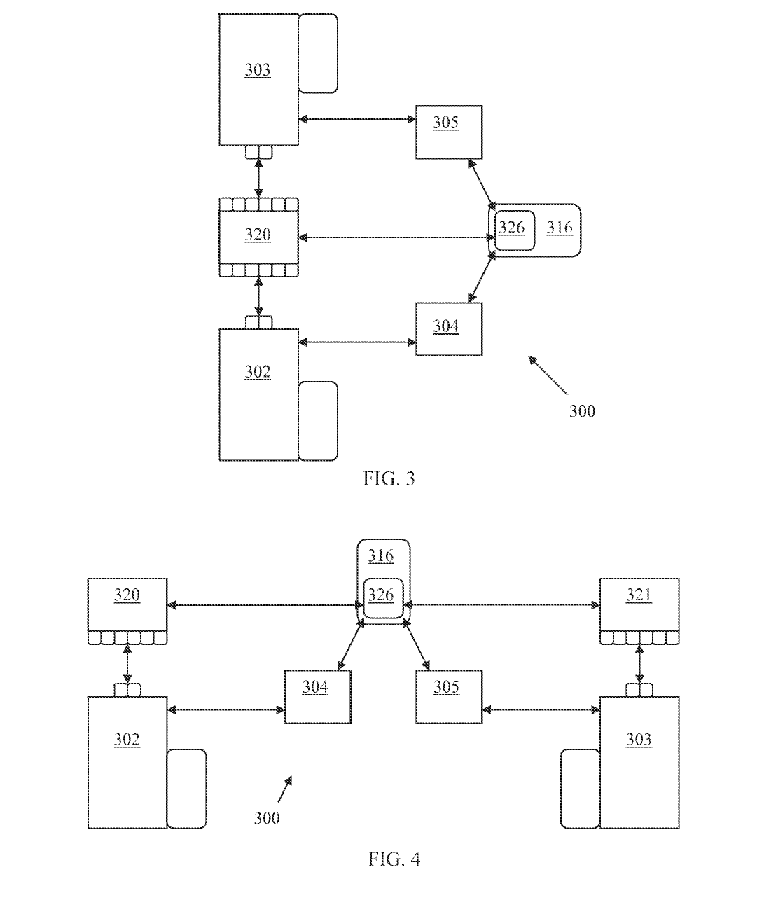

In FIG. 2, the method employed by the system 300 to transport reticles to and from the equipment unit 302 for processing during semiconductor fabrication is illustrated. At step 350, the equipment unit performs a process on substrates with a current reticle, such as a fabrication process like photolithography. At step 352, the equipment unit 302 produces equipment data, such as the identity of the current reticle being used in processing, the identity of other reticles at the equipment unit 302, the number of steps remaining in the current process using the current reticle at the equipment unit 302, the status of equipment ports 324 (whether vacant or occupied) at the equipment unit 302, a predicted process completion time for the process using the current reticle, substrate temperature data, equipment temperature data, sensor information, sensor status, process parameters, preventative maintenance data, substrate location and/or process data, robot interlock information, status of internal automation components, and/or digital inputs among other equipment information. Such equipment data may vary depending on the manufacturer of the equipment unit 302.

At step 354, the equipment unit communicates the equipment data to host 304. The host 304 communicates the equipment data to the local reticle controller (LRC) 316 at step 356. Concurrently, at step 360 the local reticle storage (LRS) unit 320 communicates to the local storage control (LSC) 316 storage data including the identity of reticle pods at the local reticle storage (LRS) unit, status of input/output ports 322 (vacant or occupied) at the local reticle storage unit 320, storage device temperature data, preventative maintenance data, carrier state information, and robot interlock information among other storage information. Such storage data may vary depending on the manufacturer of the local reticle storage unit 320.

Armed with detailed equipment data and storage data, the scheduler 326 at the local reticle controller (LRC) 316 schedules movement of reticles between the equipment unit 302 and the local reticle storage (LRS) unit 320 at step 362. The schedule and/or a transport command is communicated to the local reticle storage (LRS) unit 320 at step 364 for the removal of a current reticle from the equipment unit 302 and for the delivery of a subsequent reticle to the equipment unit 302. In response to the command, the local reticle storage (LRS) unit 320 removes the current reticle from the equipment unit 302 and delivers a subsequent reticle to the equipment unit 302 before it is needed at step 366.

As a result of the amount and type of information specific to equipment unit 302 and local reticle storage unit 320 provided to the scheduler 326, the reduced number of steps and exchanges in communicating that information, and the reduced burden on the scheduler 326, the system 300 of FIG. 1 is able to remove a current reticle from the equipment unit 302 in less than 20 seconds, less than 10 seconds, less than 5 seconds, less than 3 seconds, or less than 1 second, and most preferably in the order of milliseconds of the completion of the processing step using the current reticle. Further, the system 300 of FIG. 1 is able to deliver a subsequent reticle from the local reticle storage unit 320 to the equipment unit 302 in less than 20 seconds, less than 10 seconds, less than 5 seconds, less than 3 seconds, or less than 1 second, and most preferably in the order of milliseconds, of the completion of processing step using the current reticle.

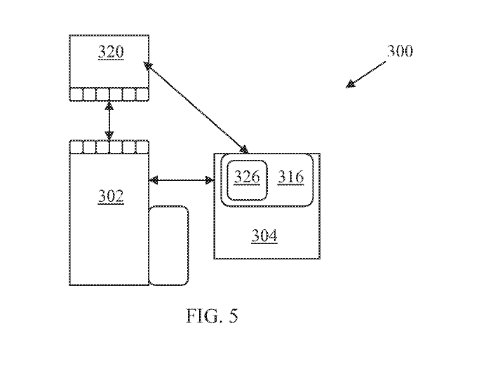

It is noted that a single equipment unit 302 associated with a single local reticle storage unit 320 is illustrated in FIG. 1. However, it is contemplated that the local reticle controller 316 may be utilized in a variety of embodiments. For instance, in FIG. 3, two equipment units 302 and 303 are serviced by a single local reticle storage unit 320. As shown, each equipment unit 302 and 303 is in communication with a respective host 304 and 305. Further, each host 304 and 305 is in communication with the local reticle controller 316. Also, the local reticle storage unit 320 is in communication with the local reticle controller 316. In the embodiment shown in FIG. 3, the scheduler 326 in the local reticle controller 316 is able to schedule the transport of reticles between the local reticle storage unit 320 and both equipment units 302 and 303. It is noted that the equipment units 302 and 303 may represent a plurality of related or associated equipment units which interact with hosts 304 and 305 respectively.

FIG. 4 depicts another embodiment, in which a local reticle controller is used to control reticle movement at two equipment units. As shown, each equipment unit 302 and 303 is associated with and serviced by a dedicated local reticle storage unit 320 and 321, respectively. Further, each equipment unit 302 and 303 communicates with its own host 304 and 305, respectively. As shown, each host 304 and 305 is in communication with the local reticle controller 316. Likewise, each local reticle storage unit 320 and 321 communicates with the local reticle controller 316. The scheduler 326 in the local reticle controller 316 is able to schedule the transport of reticles between the local reticle storage units 320 and 321 and the respective equipment unit 302 and 303. It is again noted that the equipment units 302 and 303 may represent a plurality of related or associated equipment units which interact with hosts 304 and 305 and local reticle storage units 320 and 321, respectively.

Referring to FIG. 5, an alternate embodiment is illustrated. Again, the equipment unit 302 is in communication with host 304. However, in FIG. 5, the local reticle controller 316 is positioned in, or part of, host 304. As a result, the scheduler 326 is within host 304. As shown, the host 304, local reticle controller 316 and scheduler 326 are in communication with the local reticle storage unit 320 which is able to transport reticles to and from the equipment unit 302.

In view of the various illustrated embodiments, a fabrication facility may incorporate different embodiments for local reticle management across different fabrication sectors or for different types of hosts and equipment units employing reticles. Accordingly, a semiconductor fabrication method and system with local and distributed reticle management has been provided. From the foregoing, it is to be appreciated that the exemplary embodiments of the semiconductor fabrication method and system provide for reduced idle time of equipment units between completion of a process on substrates with a current reticle and commencement of processing substrates with a subsequent reticle. Further, the semiconductor fabrication method and system schedule removal of current reticles and delivery of subsequent reticles to the equipment unit synchronized with the completion of processing with the current reticles.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the semiconductor fabrication methods and systems in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the appended claims and their legal equivalents.

What is claimed is:

1. A method of semiconductor fabrication comprising:
performing a process on substrates with an equipment unit using a current reticle;
communicating processing data from the equipment unit to a local reticle controller; and
scheduling removal of the current reticle from the equipment unit and delivery of a subsequent reticle to the equipment unit by the local reticle controller based on the processing data for further substrate processing.

2. The method of claim 1 wherein the equipment unit is a photolithography process tool or photolithography process module, and wherein the process is performed by printing images from the current reticle onto the substrates.

3. The method of claim 1 wherein the processing data is communicated directly from the equipment unit to a host, and directly from the host to the local reticle controller.

4. The method of claim 1 wherein the processing data is communicated directly from the equipment unit to the local reticle controller.

5. The method of claim 1 wherein the processing data includes the identity of the current reticle at the tool.

6. The method of claim 1 wherein the current reticle is removed from the equipment unit to a local reticle storage, wherein the subsequent reticle is delivered to the equipment unit from the local reticle storage, and wherein the local reticle controller directs delivery of subsequent reticles and removal of the current reticles.

7. The method of claim 6 wherein reticles are transported in reticle pods, wherein the local reticle storage produces reticle pod data that is communicated to the local reticle controller, and wherein the local reticle controller directs delivery of subsequent reticles and removal of the current reticles based on the reticle pod data.

8. The method of claim 6 wherein the local reticle storage delivers subsequent reticles to, and removes current reticles from, a plurality of equipment units.

9. The method of claim 1 wherein a local reticle storage is located in close proximity to the equipment unit, and wherein the method further includes removing the current reticle from the equipment unit to the local reticle storage and delivering the subsequent reticle to the equipment unit from the local reticle storage.

10. The method of claim 1 wherein the equipment unit includes a reticle pod loadport, wherein reticles are transported in reticle pods configured to interface with the reticle pod loadport, and wherein the method further includes removing the current reticle from the equipment unit to a local reticle storage in a current reticle pod and delivering the subsequent reticle to the equipment unit from the local reticle storage in a subsequent reticle pod.

11. The method of claim 1 wherein the local reticle controller delivers an empty reticle pod to remove the current reticle.

12. A method of semiconductor fabrication employing local reticle management comprising:
providing a plurality of equipment units;
associating each equipment unit to a respective local reticle controller;
performing a process on substrates with a first equipment unit using a current reticle;
communicating processing data from the first equipment unit to the associated local reticle controller; and
scheduling removal of the associated current reticle from the first equipment unit to a first local reticle storage and delivery of a subsequent reticle from the first local reticle storage to the first equipment unit by the associated local reticle controller based on the processing data.

13. The method of claim 12 wherein each equipment unit is a photolithography process tool or photolithography process module.

14. The method of claim 12 wherein the processing data is communicated directly from each equipment unit to a respective host, and directly from the respective host to the associated local reticle controller.

15. The method of claim 12 wherein processing data is communicated directly from each equipment unit to the associated local reticle controller.

16. The method of claim 12 wherein processing data includes the identity of the current reticle at the first equipment unit.

17. The method of claim 12 wherein reticles are transported in reticle pods, wherein the first local reticle storage produces reticle pod data that is communicated to the associated local reticle controller, and wherein the associated local reticle controller directs delivery of subsequent reticles and removal of the current reticle based on the reticle pod data.

18. The method of claim 12 wherein the first local reticle storage delivers subsequent reticles to, and removes current reticles from, a plurality of associated equipment units.

19. The method of claim 12 wherein the first local reticle controller delivers an empty reticle pod to remove the current reticle.

20. A semiconductor fabrication system comprising:
an equipment unit configured to perform a process on substrates using a current reticle to form processed substrates and configured to produce processing data;
a local reticle storage configured to hold reticles and to transport reticles to and from the equipment unit; and
a local reticle controller in communication with the equipment unit and the local reticle storage and configured to schedule removal of current reticles from the equipment unit and delivery of subsequent reticles to the equipment unit based on the processing data.
